(19) United States
(12) Patent Application Publication
(10) Pub. No.: US 2025/0181088 A1
(43) Pub. Date: Jun. 5, 2025

(54) LDO CIRCUIT WITH CONSTANT POWER CONSUMPTION AND WITHOUT INTERNAL COMPENSATION CAPACITOR, AND METHOD

(71) Applicant: SG MICRO CORP, Beijing (CN)

(72) Inventors: Xinmin YI, Beijing (CN); Xiaolin LIU, Beijing (CN)

(73) Assignee: SG MICRO CORP, Beijing (CN)

(21) Appl. No.: 18/845,111

(22) PCT Filed: Mar. 9, 2023
(86) PCT No.: PCT/CN2023/080485

§ 371 Date: Sep. 9, 2024

(30) Foreign Application Priority Data
Mar. 9, 2022 (CN) 202210231988.7

(51) Int. Cl. G05F 1/46; G05F 3/26

(52) U.S. Cl. CPC G05F 1/461; G05F 3/262

(57) ABSTRACT

An LDO circuit and method with constant power consumption without internal compensation capacitor, the circuit including: a power supply module, which supplies power to the LDO circuit based on a power supply and a current mirror; a bias module, which implements current bias based on a bias current and a current mirror; an output voltage divider feedback module, which feeds back the output voltage divider to the operational amplifier module based on a voltage divider resistor; an input voltage divider feedback module, which feeds back the input voltage divider to the operational amplifier module based on a voltage divider resistor; an operational amplifier module, which, based on input voltage divider feedback and output voltage divider feedback, sets the value of the offset resistor so that the output tube is always in the saturation zone, thereby achieving the purpose of keeping the circuit power consumption constant.

### RELATED APPLICATIONS

The present patent document claims the benefit of priority to CN Patent Application No.202210231988.7, filed Mar. 9, 2022, and entitled “LDO circuits with constant power consumption without internal compensation capacitor and methods” the entire contents of which are incorporated herein by reference.

### FIELD

The present disclosure belongs to the field of integrated circuit technology and relates to LDO (low dropout regulator) circuits with constant power consumption and no internal compensation capacitor and related methods.

### BACKGROUND

LDO is a low dropout regulator, which is a low voltage difference linear regulator. Traditional linear regulators, such as 78XX series chips, require the input voltage to be at least 2V to 3V higher than the output voltage, otherwise they cannot work properly. However, in some cases, such conditions are obviously too harsh. For example, when 5V is converted to 3.3V, the voltage difference between input and output is only 1.7V, which obviously does not meet the working conditions of traditional linear regulators. In response to this situation, LDO-type voltage conversion chips have been developed. LDO linear regulators have the advantages of low cost, low noise, and low static current.

In the power management chip, an LDO circuit is required to power the internal circuit. The traditional LDO circuit requires a large internal compensation capacitor, which occupies a large chip area. The existing capacitor-free LDO has the problem of increased power consumption when the input voltage drops below the preset output value, making the chip power consumption larger in this case.

### SUMMARY

In order to solve the deficiencies in the existing technologies, the present application provides an LDO circuit and method with constant power consumption and without internal compensation capacitor.

In order to achieve the above objectives, the present disclosure adopts the following technical solutions:

An LDO circuit with constant power consumption and without internal compensation capacitor includes a power supply module, a bias module, an operational amplifier module, an input voltage divider feedback module, and an output voltage divider feedback module;

The power supply module is connected to the bias module and the operational amplifier module respectively, and is used to power the LDO circuit based on the power supply VINT and the current mirror formed by the MOS tubes MC3 and MC4;

The bias module is used to realize current bias based on the bias current ibn and the current mirror formed by the MOS tubes MC1 and MC2;
the output voltage division feedback module is connected to an output voltage REGN, and is used to feed back an output voltage division to the operational amplifier module based on voltage division resistors R1 and R2;
the input voltage division feedback module is connected to an input voltage HV and is used to feed back an input voltage division to the operational amplifier module based on voltage division resistors R3 and R4;
the operational amplifier module receives output the voltage division feedback and the input voltage division feedback through input pair tubes MP1 and MP3 respectively, and is used to set the value of an offset resistor based on the input voltage division feedback and the output voltage division feedback, so that an output tube MH3 is always in the saturation zone, thereby achieving the purpose of maintaining constant circuit power consumption.

The disclosure further comprise following features.
the power supply module includes a power supply VINT of a LDO circuit error amplifier module and a current mirror formed by MOS tubes MC3 and MC4;
the MOS tubes MC3 and MC4 are both PMOS tubes, the sources of MC3 and MC4 are connected to the power supply VINT, the gates of MC3 and MC4 are connected to the bias module, and the drains of MC3 and MC4 are connected to the bias module and the operational amplifier module respectively.
the bias module includes a bias current ibn and a current mirror formed by MOS tubes MC1 and MC2;
the MOS tubes MCI and MC2 are both NMOS tubes, the sources of MCI and MC2 are connected to a ground potential GND, the gates of MCI and MC2 are connected to the bias current ibn, and the drains of MCI and MC2 are connected to the bias current ibn and the power supply module respectively.
the output voltage division feedback module includes voltage division resistors R1 and R2;
one end of the resistor R1 is connected to an output voltage REGN of the LDO circuit, and the other end is connected to one end of the resistor R2 and an input pair MP1;
the other end of the resistor R2 is connected to the ground potential GND;
the voltage division resistors R1 and R2 divide the output voltage REGN according to the voltage division coefficient k to obtain an output voltage division feedback voltage vfb, and feed it back to the input pair MP1 of the operational amplifier module.
the input voltage division feedback module includes voltage division resistors R3 and R4;
one end of the resistor R3 is connected to the input voltage HV of the LDO circuit, and the other end is connected to one end of the resistor R4 and the input pair MP3;
the other end of the resistor R4 is connected to the ground potential GND;

The voltage division resistors R3 and R4 divide the input voltage HV according to the voltage division coefficient k to obtain the input voltage division feedback voltage hv_fb, and feed it back to the input pair MP3 of the operational amplifier module.
the operational amplifier module includes input pair tubes MP1, MP2 and MP3, offset resistors R0, R0, current mirror loads formed by MOS tubes MN1 and MN2, and high-voltage tubes MH1, MH2, MH3;
the input pair tubes MP1, MP2 and MP3 are all PMOS tubes;
the MOS tubes MN1 and MN2, the high-voltage tube MH1 are all NMOS tubes, and MH2 and MH3 are both PMOS tubes;
the gate of the input pair tube MP1 is the output voltage divider feedback access terminal, the source of the input pair tube MP1 is connected to the power supply module through the offset resistor R0, and the drain the input pair tube MP1 is connected to the gate of MH1 and the drain of MN2;
the source of MH1 is connected to the ground potential G ND, the drain of MH1 is connected to the gates of MH2 and MH3 and the drain of MH2;

The sources of MH2 and MH3 are both connected to the input voltage HV, MH3 is an output tube, and the drain of MH3 is connected to the output voltage REGN;
the source of MN2 is connected to the ground potential GND, and the gates of MN1 and MN2 are both connected to the drain of MP2 and the drain of MP3;
the source of MN1 is connected to the ground potential GND, and the drain is connected to the drain of MP3;
the gate of MP3 is the input voltage divider feedback access terminal, and the source of MP3 is connected to the power supply module;
the gate of MP2 is connected to the reference voltage vbg, and the source of MP2 is connected to one end of the offset resistor R0, and the other end is connected to the connection point between R0 and the power supply module.

Resistance R1:R2=R3:R4, R0=R0.

A method for maintaining constant power consumption without internal compensation capacitor, further comprise following steps:
Step 1: Setting the voltage division coefficient k from REGN to vfb, setting R1:R2=R3:R4, then vfb=kREGN, hv_fb=kHV;
Step 2: ignoring the area where MP3 and MP2 work together, and analyzing the output voltage REGN respectively when MP2 and MP3 working alone;
Step 3: based on the output voltage REGN, analyzing the drain-source voltage VDS of the output tube MH3;
Step 4: based on the VDS value of the output tube MH3 obtained by analysis, setting the values of R0 and R0, so that the output tube MH3 is always in the saturation area, thereby achieving the purpose of keeping the circuit power consumption constant.

Furthermore, in step 2, when only MP2 works, the output voltage REGN=vbg/k;

When only MP3 works, hv_fb=vfb+ΔV;
wherein ΔV is the voltage drop on R0, so the output voltage REGN=HV−(ΔV/k).
in step 3, when HV>(vbg+ΔV)/k, hv_fb>vbg, only MP2 works, and at this time, the VDS of the output tube MH3, VDS=HV−REGN=HV−(vbg/k)>ΔV/k;
when HV<(vbg+ΔV)/k, only MP3 works, and at this time, the VDS of the output tube MH3, VDS=HV−REGN=ΔV/k;
therefore, the VDS value of the output tube MH3 is greater than or equal to ΔV/k.

Technical effects achieved by the present application:

The present application proposes an LDO circuit with constant power consumption without internal compensation capacitor, which achieves the purpose of making the power consumption of the LDO circuit constant by introducing input voltage division feedback and output voltage division feedback while eliminating the internal compensation capacitor, as well as the related methods.

### BRIEF DESCRIPTION OF THE DRAWINGS

FIG. 1 is a structural diagram of an LDO circuit with constant power consumption without internal compensation capacitor provided in the Embodiment 1 of the present application.

### DETAILED DESCRIPTION

The present application is further described below in conjunction with the accompanying drawings. The following embodiments are only used to more clearly illustrate the technical solution of the present disclosure, and cannot be used to limit the protection scope of the present application.

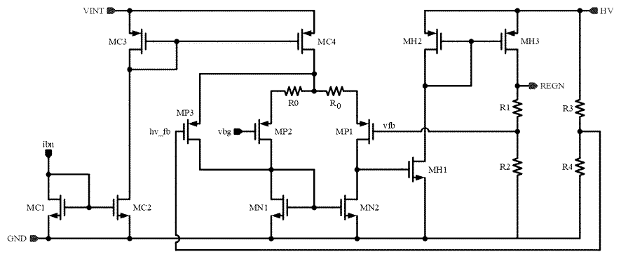

As shown in FIG. 1, Embodiment 1 of the present application provides an LDO circuit with constant power consumption without internal compensation capacitor, including a power supply module, a bias module, an operational amplifier module, an input voltage division feedback module, and an output voltage division feedback module. In a preferred but non-limiting embodiment of the present application, the power supply module is respectively connected to the bias module and the operational amplifier module, and is used to power the LDO circuit based on a current mirror composed of a power supply VINT and MOS tubes MC3 and MC4;

Further, the power supply module includes a power supply VINT of the LDO error amplifier part and a current mirror formed by MOS tubes MC3 and MC4;

The MOS tubes MC3 and MC4 are both PMOS tubes, the sources of MC3 and MC4 are both connected to the power supply VINT, the gates of MC3 and MC4 are both connected to the bias module, and the drains of MC3 and MC4 are respectively connected to the bias module and the operational amplifier module.

The bias module is used to realize current bias based on the bias current ibn and the current mirror formed by the MOS tubes MC1 and MC2;

The MOS tubes MC1 and MC2 are both NMOS tubes, the sources of MC1 and MC2 are both connected to the ground potential GND, the gates of MC1 and MC2 are both connected to the bias current ibn, and the drains of MC1 and MC2 are respectively connected to the bias current ibn and the power supply module.

The output voltage division feedback module is connected to the output voltage REGN, and is used to feed back the output voltage division to the operational amplifier module based on the voltage division resistors R1 and R2;

Further, the output voltage division feedback module includes voltage division resistors R1 and R2;

One end of the resistor R1 is connected to the output voltage REGN of the LDO circuit, and the other end is connected to one end of the resistor R2 and the input pair MP1;

The other end of the resistor R2 is connected to the ground potential GND;

The voltage division resistors R1 and R2 divide the output voltage REGN according to the voltage division coefficient k to obtain an output voltage division feedback voltage vfb, and feed vfb back to the input pair MP1 of the operational amplifier module.

The input voltage division feedback module is connected to the input voltage HV and is used to feed back the input voltage division to the operational amplifier module based on the voltage division resistors R3 and R4;

Further, the input voltage division feedback module includes voltage division resistors R3 and R4;

One end of the resistor R3 is connected to the input voltage HV of the LDO, and the other end is connected to one end of the resistor R4 and the input pair MP3;

The other end of the resistor R4 is connected to the ground potential GND;

The voltage division resistors R3 and R4 divide the input voltage HV according to the voltage division coefficient k to obtain an input voltage division feedback voltage hv_fb, and feed hv_fb back to the input pair tube MP3 of the operational amplifier module.

The operational amplifier module receives output voltage division feedback and input voltage division feedback through the input pair tubes MP1 and MP3 respectively, and is used to set the value of the offset resistor R0 based on the input voltage division feedback and the output voltage division feedback, so that the output tube MH3 is always in the saturation zone, thereby achieving the purpose of maintaining constant circuit power consumption.

Further, the operational amplifier module includes input pair tubes MP1, MP2 and MP3, offset resistors R0, R0, a current mirror load formed by MOS tubes MN1 and MN2, and high voltage tubes MH1, MH2, MH3;

The input pair of tubes MP1, MP2 and MP3 are all PMOS tubes;

The MOS tubes MN1 and MN2 and the high voltage tube MH1 are all NMOS tubes, and MH2 and MH3 are all PMOS tubes;

The gate of the input pair MP1 is the output voltage divider feedback access terminal, the source is connected to the power supply module through the offset resistor R0, and the drain is connected to the gate of MH1 and the drain of MN2;

The source of MH1 is connected to the ground potential GND, and the drain is connected to the gates of MH2 and MH3 and the drain of MH2;

The sources of MH2 and MH3 are connected to the input voltage HV, MH3 is an output tube, and its drain is connected to the output voltage REGN;

The source of MN2 is connected to the ground potential GND, and the gates of MN1 and MN2 are connected to the drain of MP2 and the drain of MP3;

The source of MN1 is connected to the ground potential GND, and the drain is connected to the drain of MP3;

The gate of MP3 is the input voltage divider feedback access terminal, and the source is connected to the power supply module;

The gate of MP2 is connected to the reference voltage vbg, the source is connected to one end of the offset resistor R0, and the other end is connected to R0 and the power supply module.

Further, the resistors R1:R2=R3:R4, and R0=R0.

The present application also provides a method for maintaining constant power consumption of an LDO circuit without an internal compensation capacitor based on the above-mentioned LDO circuit without an internal compensation capacitor, the method comprising the following steps:
Step 1: Set the voltage divider coefficient k from REGN to vfb, R1:R2=R3:R4, then vfb=kREGN, hv_fb=kHV;
Step 2: Ignore the area where MP3 and MP2 work together, and analyze the output voltage REGN respectively when MP2 and MP3 work alone:

When only MP2 works, the output voltage REGN=vbg/k;

When only MP3 works, hv_fb=vfb+ΔV;

Where ΔV is the voltage drop on R0 (ignoring the substrate bias effect), so the output voltage REGN=HV−(ΔV/k).
Step 3: Based on the output voltage REGN, analyze the VDS of the output tube MH3;

When HV>(vbg+ΔV)/k, hv_fb>vbg, only MP2 works, at this time, the VDS of the output tube MH3, VDS=HV−REGN=HV−(vbg/k)>ΔV/k;

When HV<(vbg+ΔV)/k, only MP3 works, and VDS of output tube MH3, VDS=HV−REGN=ΔV/k;

Therefore, the VDS value of the output tube MH3 is greater than or equal to ΔV/k.
Step 4: Based on the VDS value of the output tube MH3 obtained by the analysis, the values of R0 and R0 are set to ΔV divided by the current flowing through R0, so that the output tube MH3 is always in the saturation zone, thereby achieving the purpose of keeping the circuit power consumption constant.

This application proposes an LDO circuit and method with constant power consumption without internal compensation capacitor. While eliminating the internal compensation capacitor, the input feedback is introduced to achieve the purpose of making the power consumption of the LDO circuit constant.

The applicant of the present application has made a detailed explanation and description of the implementation examples of the present application in conjunction with the drawings of the specification, but those skilled in the art should understand that the above implementation embodiments are only preferred implementation schemes of the present application, and the detailed description is only to help readers better understand the spirit of the present application, and is not a limitation on the protection scope of the present application. On the contrary, any improvement or modification based on the inventive spirit of the present application should fall within the protection scope of the present application.

1-10. (canceled)

11. An LDO circuit with constant power consumption without internal compensation capacitor including a power supply module, a bias module, an operational amplifier module, an input voltage division feedback module and an output voltage division feedback module, comprising:
the power supply module is connected to the bias module and the operational amplifier module respectively, and is used to power the LDO circuit based on a power supply VINT and a current mirror formed by MOS tubes MC3 and MC4;
the bias module is used to realize current bias based on a bias current ibn and the current mirror formed by the MOS tubes MC1 and MC2;
the output voltage division feedback module is connected to an output voltage REGN, and is used to feed back an output voltage division to the operational amplifier module based on voltage division resistors R1 and R2;
the input voltage division feedback module is connected to an input voltage HV and is used to feed back an input voltage division to the operational amplifier module based on voltage division resistors R3 and R4;
the operational amplifier module receives output the voltage division feedback and the input voltage division feedback through input pair tubes MP1 and MP3 respectively, and is used to set the value of an offset resistor based on the input voltage division feedback and the output voltage division feedback, so that an output tube MH3 is always in the saturation zone, thereby achieving the purpose of maintaining constant circuit power consumption.

12. The LDO circuit with constant power consumption without internal compensation capacitor according to claim 11, further comprising:
the power supply module includes a power supply VINT of a LDO circuit error amplifier module and a current mirror formed by MOS tubes MC3 and MC4;
the MOS tubes MC3 and MC4 are both PMOS tubes, the sources of MC3 and MC4 are connected to the power supply VINT, the gates of MC3 and MC4 are connected to the bias module, and the drains of MC3 and MC4 are connected to the bias module and the operational amplifier module respectively.

13. The LDO circuit with constant power consumption without internal compensation capacitor according to claim 12, further comprising:
the bias module includes a bias current ibn and a current mirror formed by MOS tubes MC1 and MC2;
the MOS tubes MC1 and MC2 are both NMOS tubes, the sources of MC1 and MC2 are connected to a ground potential GND, the gates of MC1 and MC2 are connected to the bias current ibn, and the drains of MC1 and MC2 are connected to the bias current ibn and the power supply module respectively.

14. The LDO circuit with constant power consumption without internal compensation capacitor according to claim 13, further comprising:
the output voltage division feedback module includes voltage division resistors R1 and R2;
one end of the resistor R1 is connected to an output voltage REGN of the LDO circuit, and the other end is connected to one end of the resistor R2 and an input pair MP1;
the other end of the resistor R2 is connected to the ground potential GND;
the voltage division resistors R1 and R2 divide the output voltage REGN according to the voltage division coefficient k to obtain an output voltage division feedback voltage vfb, and feed it back to the input pair MP1 of the operational amplifier module.

15. The LDO circuit with constant power consumption without internal compensation capacitor according to claim 14, further comprising:
the input voltage division feedback module includes voltage division resistors R3 and R4;
an end of the resistor R3 is connected to the input voltage HV of the LDO circuit, and the other end is connected to one end of the resistor R4 and the input pair MP3;
the other end of the resistor R4 is connected to the ground potential GND;
The voltage division resistors R3 and R4 divide the input voltage HV according to the voltage division coefficient k to obtain the input voltage division feedback voltage hv_fb, and feed it back to the input pair MP3 of the operational amplifier module.

16. The LDO circuit with constant power consumption without internal compensation capacitor according to claim 15, further comprising:
the operational amplifier module includes input pair tubes MP1, MP2 and MP3, offset resistors R0, R0, current mirror loads formed by MOS tubes MN1 and MN2, and high-voltage tubes MH1, MH2, MH3;
the input pair tubes MP1, MP2 and MP3 are all PMOS tubes;
the MOS tubes MN1 and MN2, the high-voltage tube MH1 are all NMOS tubes, and MH2 and MH3 are both PMOS tubes;
the gate of the input pair tube MP1 is the output voltage divider feedback access terminal, the source of the input pair tube MP1 is connected to the power supply module through the offset resistor R0, and the drain the input pair tube MP1 is connected to the gate of MH1 and the drain of MN2;
the source of MH1 is connected to the ground potential G ND, the drain of MH1 is connected to the gates of MH2 and MH3 and the drain of MH2;
The sources of MH2 and MH3 are both connected to the input voltage HV, MH3 is an output tube, and the drain of MH3 is connected to the output voltage REGN;
the source of MN2 is connected to the ground potential GND, and the gates of MN1 and MN2 are both connected to the drain of MP2 and the drain of MP3;
the source of MN1 is connected to the ground potential GND, and the drain is connected to the drain of MP3;
the gate of MP3 is the input voltage divider feedback access terminal, and the source of MP3 is connected to the power supply module;
the gate of MP2 is connected to the reference voltage vbg, and the source of MP2 is connected to one end of the offset resistor R0, and the other end is connected to the connection point between R0 and the power supply module.

17. The LDO circuit with constant power consumption without internal compensation capacitor according to claim 16, further comprising:
Resistance R1:R2=R3:R4, R0=R0.

18. A method for maintaining constant power consumption without internal compensation capacitor based on the LDO circuit without internal compensation capacitor in claim 16, further comprising:
the method comprises the following steps:
Step 1: Setting the voltage division coefficient k from REGN to vfb, setting R1:R2=R3:R4, then vfb=kREGN, hv_fb=kHV;
Step 2: ignoring the area where MP3 and MP2 work together, and analyzing the output voltage REGN respectively when MP2 and MP3 working alone;
Step 3: based on the output voltage REGN, analyzing the drain-source voltage VDS of the output tube MH3;
Step 4: based on the VDS value of the output tube MH3 obtained by analysis, setting the values of R0 and R0, so that the output tube MH3 is always in the saturation area, thereby achieving the purpose of keeping the circuit power consumption constant.

19. A method for maintaining constant power consumption without internal compensation capacitor according to claim 18, further comprising:
in step 2, when only MP2 works, the output voltage REGN=vbg/k;
When only MP3 works, hv_fb=vfb+ΔV;
wherein ΔV is the voltage drop on R0, so the output voltage REGN=HV−(ΔV/k).

20. A method for maintaining constant power consumption without internal compensation capacitor according to claim 19, further comprising:
in step 3, when HV>(vbg+ΔV)/k, hv_fb>vbg, only MP2 works, and at this time, the VDS of the output tube MH3, VDS=HV−REGN=HV−(vbg/k)>ΔV/k;
when HV<(vbg+ΔV)/k, only MP3 works, and at this time, the VDS of the output tube MH3, VDS=HV−REGN=ΔV/k;
therefore, the VDS value of the output tube MH3 is greater than or equal to ΔV/k.
